(19) United States
(12) Patent Application Publication
(10) Pub. No.: US 2013/0106211 A1
(43) Pub. Date: May 2, 2013

(54) ROTOR FOR ELECTRICAL MACHINE, IN PARTICULAR FOR A SYNCHRONOUS MOTOR

(71) Applicant: Andreas Holzner, Inzell (DE)

(72) Inventor: Andreas Holzner, Inzell (DE)

(73) Assignee: BRUSA ELEKTRONIK AG, Sennwald (CH)

(21) Appl. No.: 13/703,773

(22) PCT Filed: Jul. 14, 2011
(86) PCT No.: PCT/IB11/53152

§ 371 Date: Jan. 14, 2013

Related U.S. Application Data
(60) Provisional application No. 61/364,439, filed on Jul. 15, 2010.

(30) Foreign Application Priority Data
Jul. 14, 2010 (EP) 10169565

(51) Int. Cl. H02K 3/51; H02K 9/06

(52) U.S. Cl. CPC H02K 3/51; H02K 9/06
USPC 310/62; 310/194

(57) ABSTRACT

Electrical machine rotors (R) suited for synchronous motors of electric vehicle drives. A rotor (R) includes a rotor shaft (8), a sheet stack (3), windings, and a restraining system (2) with support elements. The support elements of the restraining system include support rings (7) to protect winding heads (4) projecting from the sheet stack (3) in the axial direction against radial stresses. The elements of the restraining system (2) protecting the winding heads (4) from stresses also include axially inner end caps (6) configured as supports for the finished winding heads (4) in the operating state, and as guides and supports during the winding of the pole windings of the rotor (R) about the axial edge of the sheet stack (3). The axially outer support rings (7) cooperate with the axially inner end caps (6) so that the support rings (7) may absorb centrifugal forces acting on winding heads (4) end caps (6).

This application is a 35 U.S.C. 371 national-phase entry of PCT International application no. PCT/IB2011/053152 filed on Jul. 14, 2011 and also claims benefit of priority to European application no. EP10169565 filed on Jul. 14, 2010, and also claims benefit of priority as a non-provisional of U.S. provisional application Ser. No. 61/364,439 filed on Jul. 15, 2010, and parent application PCT/IB2011/053152, European application no. EP10169565 and U.S. provisional application Ser. No. 61/364,439 are all incorporated herein by reference in their respective entireties, as to all their parts, for all intents and purposes, as if identically set forth in full herein.

### TECHNICAL FIELD OF THE INVENTION

The present invention relates to a rotor construction for an electrical machine, in particular a synchronous motor of electric vehicle drives, wherein the rotor comprises a rotor shaft, a sheet stack, windings, and a restraining system with support elements.

### PRIOR ART

When the rotor of a synchronous motor rotates, at high rotational speeds high radial forces occur in the rotor coils which attempt to bend the coil end or winding heads radially outwards. The main task of the restraining system of the rotor is to protect the winding heads projecting from the sheet stack in the axial direction from such radial stresses.

U.S. Pat. No. 3,991,333 describes a support device for windings of a superconducting generator rotor where a plurality of modular sections of the windings is provided. Each winding section is supported separately by a support element in order to reduce the loading on the winding during operation. Winding sections and support elements are additionally fixed in an outer tube. The above arrangement on the one hand requires a complex and costly construction, on the other hand the windings there and the support elements must be machined with small tolerance, which is problematical from the production technology viewpoint. Since, however, this comprises a superconducting generator rotor and not a generator or motor which can be used in manifold ways in large numbers, such as for electromobility for example, the necessary expenditure plays a minor role.

Known from US-2008/0272671 A1 is another support device for windings of a generator rotor in which the support elements of the restraining system are configured as support rings which protect winding heads projecting from the sheet stack in the axial direction and which can be mounted on the rotor shaft on the front side. The rotor here is also provided with an additional rotor can which is extended beyond front sides of the rotor and receives the two support rings and prevents their radial movement. Due to the use of the additional metal tube can, however, the rotor has an even more complex and heavier constructions which is associated with high production technology demands.

### SUMMARY OF THE INVENTION

It is the object of the invention to provide an improved rotor design by which means the aforesaid disadvantages of the prior art can be reduced or eliminated, i.e. by which means on the one hand the rotor design can be made simpler, more compact, stiffer and cheaper, on the other hand all the stresses occurring, both static and dynamic, can be absorbed better than in the prior art, and the mutual negative influence of the rotor components can be decoupled. In addition, the motor should be designable for high rotational speeds.

This formulated object is solved by versions of the invention.

The present invention relates to a rotor of an electrical machine, in particular a synchronous motor of electric vehicle drives, which rotor comprises a rotor shaft, a sheet stack, windings, and a restraining system. The restraining system has support elements, which include two support rings which protect winding heads projecting from the sheet stack in the axial direction against stresses. The essence of the invention is seen in that the elements of the restraining system protecting the winding heads from stresses also include axially inner end caps which according to the invention can be used not only as support means for the finished winding heads but also as guide and support means for the winding of the pole windings of the rotor about the axial edge of the sheet stack. On the other hand the axially outer support rings cooperate with the axially inner end caps in such a manner that the support rings can absorb the centrifugal forces acting on the end caps from the winding heads and at the same time can also compensate for imbalances which have a negative effect primarily at high centrifugal forces (high rotational speeds). Here the inventor is guided by the inventive consideration that in motor windings, imbalances can form in the area of the winding heads and it is therefore logical to compensate for these in particular in this area.

The formulated object is completely solved by the proposed configuration of the rotor, whereby a simpler, more compact, stiffer and cheaper rotor design and also a better and simpler winding and more stable winding heads as well great running smoothness can be achieved despite high centrifugal forces (even at n=12,000 rpm). This results in an advantage over the structures from the prior art.

According to a particular version of the invention, the rotor as well as the end caps and the outer support ring of the restraining system are connected by means of clamping screws through a predetermined pretension to form a compact rotor stack. This pretension of the rotor stack can have a value of about 4500-4900 N, preferably 4700 N per clamping element.

In this case, it is further provided that, in the assembled state of the rotor, the end caps are arranged at least in one of the outer support rings of the restraining system with a predetermined axial play so that if necessary they can expand or contract freely in the axial direction and as a result thermal stresses are decoupled from the rotor concept described or do not occur at all in the first place.

In order to adhere to the strength limits of the clamping screws of the rotor stack and for improved electrical insulation of the adjacent pole windings of the rotor, according to a further development of the invention a pole separating layer is provided in the cavities between the windings, in particular by potting with, for example, epoxy resin or by inserting a correspondingly configured plastic body. By means of a suitable choice of the potting material or plastic, the thermal connection from the core of the winding to the periphery can be improved. With improved heat removal, the costs for the rotor stack overall can be reduced since the requirement for the thermal load-bearing capacity of the materials used decreases and therefore more favourable materials can be avoided.

According to a further feature of the invention, each end cap of the restraining system for each winding head can be configured as a single piece. In this case, instead of a closed one-piece annular support with end caps formed in one piece, individual end caps are used which are placed independently of one another on the winding heads on the front side or fixed on the sheet stack, preferably glued, only in the region of the respective axial web of the pole shoe. As a result, end caps which are cheap but fulfill two important functions can be provided. They are only then supported and secured by the support ring in particular against centrifugal force. By means of this measure, a plurality of components (end caps) of the same type can be manufactured in advance with a relative simple tool, which are only assembled on the rotor. The tool costs and therefore the manufacturing costs are therefore lower than for a single-part end cap unit per front side of the rotor stack.

Preferably at least one of the outer support rings of the restraining system is provided with at least one predetermined balancing weight, e.g. an accumulation of material, for dynamic balancing of the rotor stack.

According to a further development, any support ring together with any supports, in particular supporting feet, can be formed from a stiff material, in particular manufactured from steel. In the various possible embodiments, the support ring of the restraining system according to the invention or the supporting feet can be supported directly or indirectly on the sheet stack of the rotor.

The end caps of the restraining system can be made of a light metal, in particular of aluminium, in particular of an Al—Mg alloy or optionally of a corresponding plastic.

One exemplary embodiment of the invention provides that the support ring of the restraining system according to the invention is supported on the sheet stack or at a position of the end caps very close to the sheet stack, e.g. by means of axial supporting feet. The two support rings located on the front side are pre-tensioned with one another via the sheet stack by means of clamping screws disposed in the pole gaps. The support ring is consequently arranged independently of or with respect to the end caps and is connected to the sheet stack to form a rigid structure (rotor stack).

The restraining system according to the invention can consequently fulfill the following functions:

It absorbs the radial forces of the coil ends (winding heads) in operation and is thereby reliably supported on the sheet stack;

The end caps support the coils during winding, i.e. they additionally serve as a guide for the windings along the front side of the sheet stack or the pole shank;

The support rings optionally serve as balancing weight carriers in order to allow a high balancing quality of the entire rotor.

It is used as thermal decoupling of the various components, i.e. due to the construction according to the invention, function-specific materials such as, for example end cap made of plastic or aluminium, can be used without this leading to an uncontrolled imbalance, as a result of thermal expansion.

Furthermore, the invention could be designed so that the clamping screws used for axial tension are configured to be hollow to allow a passage of cooling medium (air). This structure can be further improved by designing the hollow screws at their two ends each with oppositely acting wind wings, or vanes, for speed-dependent improved cooling and air passage through the pole gap. Optionally, the supporting feet of the support rings could be configured as fan blades to further promote the cooling effect by air transport.

The clamping screws are preferably each guided in a plastic body which is inserted in respectively one pole gap and separates the windings electrically from one another. The plastic body for holding the clamping screw should conduct thermally as well as possible, but not electrically. This results in a reduced weight and an improved thermal connection, which allows a further improved cooling because less heat flow resistance occurs and nevertheless the rotor as such remains compact.

As a result of the high rotational speeds, large radial forces act on the coils which are passed via the end caps to the support ring which can readily absorb this stress, according to the invention and as a result of its closed annular geometry. The support ring can additionally be provided with a balancing ring or with balancing elements so that the support ring also serves as a basis for the dynamic balancing of the rotor. Preferably in a structure-simplifying manner and according to the invention, the function of balancing is hereby integrated directly in the support ring because the balancing quality is thereby rigidly connected to the rotor construction and need not be transferred via an additional path, say an additional component with additional interfaces. Balancing weights for the fine balancing of the complete rotor can therefore be mounted on the supporting feet of the support ring and/or on the support ring itself or on the additional balancing ring, which is an additional advantage of the invention with synergistic effect. Alternatively, a local accumulation of material can be provided which results in the necessary balancing quality by local removal of material, e.g. by holes, grinding or milling.

### BRIEF DESCRIPTION OF THE DRAWINGS

The invention is explained in detail hereinafter with reference to the appended drawings, which illustrate a preferred exemplary embodiment of the solution according to the invention. In the figures:

FIG. 1 shows an exploded view of a rotor stack according to the invention with the proposed restraining system of end caps and a support ring;

FIG. 2 shows a spatial sectional view of a part of the rotor stack from FIG. 1 in the assembled state, on an enlarged scale;

FIG. 3 shows a perspective view of an integrated annular version of six end caps;

FIG. 4 shows a perspective sectional view of a rotor segment from FIG. 1 in the assembled state and on an enlarged scale.

### DETAILED DESCRIPTION

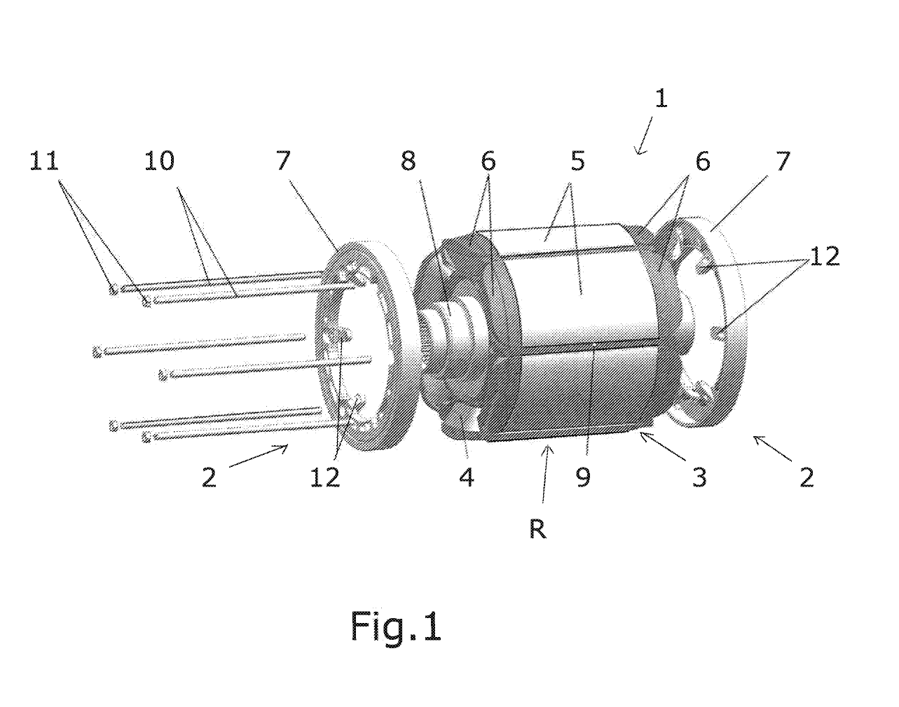

FIG. 1 shows a rotor stack 1 according to the invention comprising a rotor R and an exemplary embodiment of a proposed restraining system 2 in an exploded view. The restraining system 2 according to the invention comprises inner end caps 6 and respectively one outer support ring 7 on both sides and is substantially provided as a protecting device in order to adequately support the winding heads 4 projecting from a sheet stack 3 in the axial direction on both front sides of the rotor 6, and possibly winding regions which emerge between pole shoes 5 of the rotor R, even at higher rotational speeds of the rotor R. In FIG. 1 a shaft of the rotor R is designated with 8.

The rotor stack 1 provided with the restraining system 2 according to the invention is particularly suited for a rotor R of a current-excited synchronous motor (SSM) or another electric motor having a winding on the rotor, in particular for vehicle drives and at the same time in particular for mass production.

As known, on the front sides of the rotor R the winding heads 4 result from a winding of the six single poles with preferably one enameled copper wire (FIG. 1). In order to be able to achieve an optimal filling, i.e. the highest possible degree of filling of the winding, the pole geometry in the winding head 4 should be continued continuously along a trajectory.

During operation of an electric motor, very large centrifugal forces are produced in the winding heads 4. In particular, however, high rotational speeds (around 12,000 rpm) require additional measures in the synchronous motors since this would otherwise inevitably result in damage to the winding heads 4 and therefore to destruction of the motor and associated with this, an uncontrollable driving situation in the case of vehicle drives.

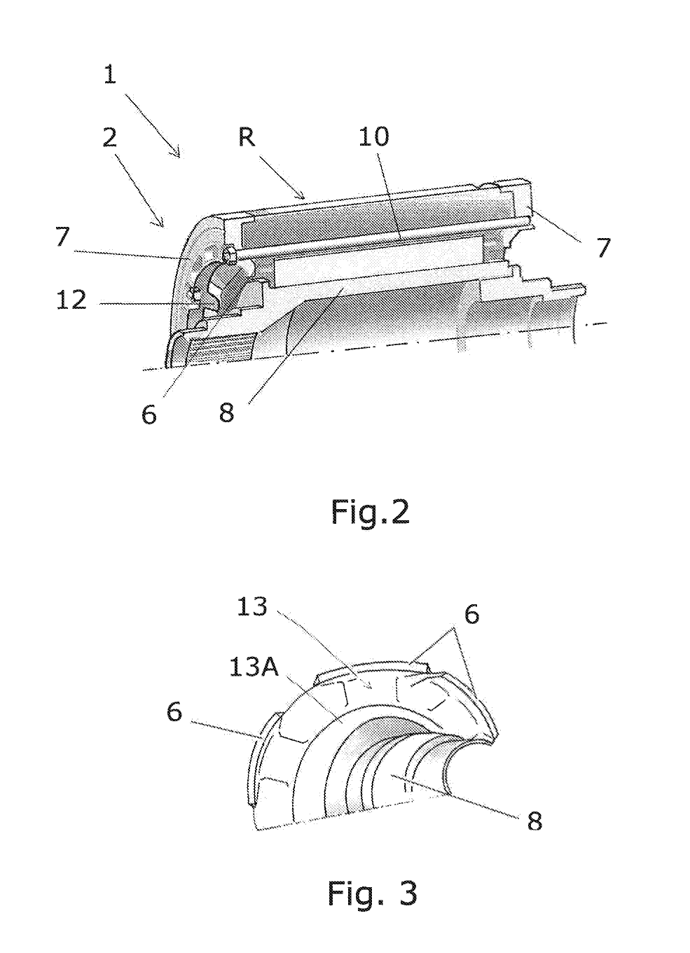

This object is completely fulfilled by the restraining system 2 according to the invention which for supporting the winding heads 4 also includes the proposed end caps 6 which absorb the stress on the relevant winding heads 4 and pass it onto the support ring 7 which in turn can optimally absorb this stress as a result of the closed annular geometry (see FIGS. 1 and 2). The end caps 6 and the support rings 7 therefore cooperate according to the invention in this sense of the force transmission. The support rings at the same time take on the balancing function and consequently ensure the running smoothness along with the stability. The end caps 6 according to the invention can therefore be made of cheap and light metal, e.g. aluminium or of a suitable plastic.

In the exemplary embodiment shown (see FIGS. 1, 2 and 4), individual separate end caps 6 are provided per winding head 4 which can firstly absorb the forces during winding and then the centrifugal forces during real operation of the electric motor. In the embodiment shown these forces are transferred outwards at least in part and absorbed on both sides by the support rings 7 of the restraining system 2 according to the invention.

FIG. 3 shows an alternative structure with integrated end caps 6, where the six end caps 6 per side are combined into an end cap structural unit, i.e. are connected by a step 13 to a common ring 13A. This structural unit of the end caps 6 can, for example, be formed by injection moulding. The ring 13A is supported on the rotor shaft 8 or on the sheet stack 3 of the rotor R. The step 13 can be provided on a radially outer side of the end caps 6 (see FIG. 3). That is a recess for the protecting ring 7 which overlaps there (without thereby increasing the overall outside diameter of the rotor R). The step 13 of the end cap 6 is provided with some play in the axial direction, where the supporting ring 7 itself is sufficiently rigid. One advantage of the end cap unit designed in one piece is that this is easier to mount and therefore allows a more rapid rotor assembly and in addition, the costs caused by the increase in the number of items, e.g. in a six-pole machine, by a factor of six, can be reduced significantly.

Another important aspect of one embodiment of the invention is that the end caps 6 can preferably expand in the axial direction as a result of an increase in temperature without thereby axially displacing the support ring 7 which could possibly result in some imbalance. Any movements of the support ring 7 itself should preferably be prevented with regard to the necessary balancing quality.

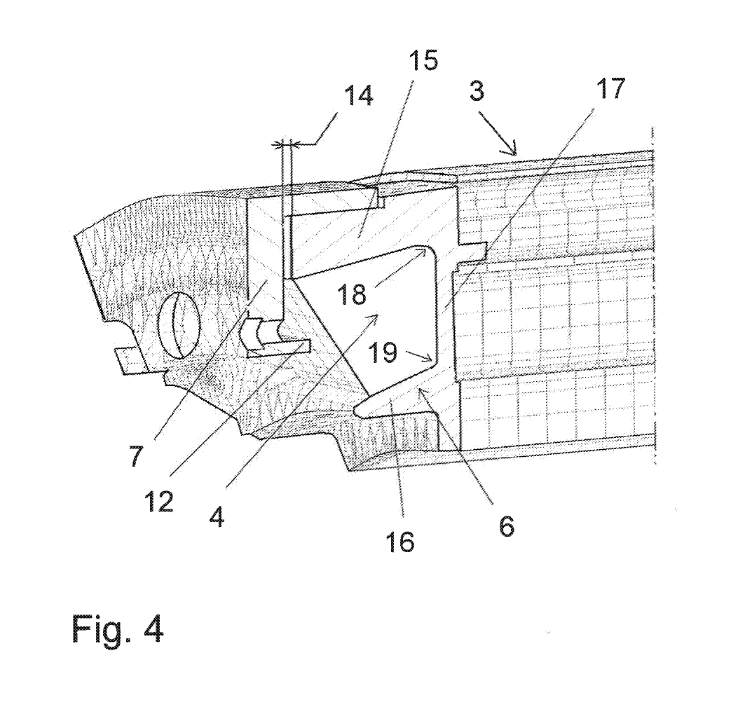

FIG. 4 shows a perspective sectional view of a part of the rotor from FIG. 1 in the assembled state and on an enlarged scale (similarly to FIG. 2 but without a clamping screw). An axial play 14 is provided between the support ring 7 and the end cap 6 for free thermal expansion, the value of which for example can be about 0.5-0.8 mm.

The cross-section of the end cap 6 can also be seen as an example in FIG. 4, which intentionally has a special cross-sectional shape, in this case possibly a horizontal U shape in order to be able to achieve a better and simpler winding of the rotor and sufficiently supported and stable winding heads despite larger centrifugal forces (even at 12,000 rpm). An upper shank 15 and a lower shank 16 as well as an inner vertical side 17 of the U-shaped end cap 6 guide and reliably support the turns around the axial edge of the sheet stack during winding and support the coil heads during operation.

As already mentioned, the end caps 6 can fulfill the following objects: to achieve a high degree of filling in the winding by supporting and guiding the turns about the axial edge of the sheet stack 3 during winding of the rotor and on the other hand, to transfer the higher centrifugal forces of the winding heads 4 to the support rings 7 during operation of the synchronous motor. An additional object of the end caps 6 is the insulation of the pole winding (if these are made from an electrically insulating plastic or a surface-treated aluminium).

During our experiments we have found that from the above objects the following requirements can be determined for the end cap 6:

Continuous extension of the winding cross-section on the front side of the pole along a trajectory (optimal degree of filling);

Securing the position of the winding head even at high rotational speed;

The smallest possible installation space requirement;

Low weight for reduction of the radial inertial mass whereby higher dynamics of the motor can be achieved;

Temperature resistance of the system depending on the boundary conditions such as cooling concept and performance class of the motor.

The end caps 6 allow optimal conditions for the maximum degree of filling and a harmonic function-oriented concept combined with the support ring 7, and a functional separation under unfavourable influences such as, for example, thermal expansions and with a suitable choice of material, an active pole insulation with respect to electric currents.

The geometrical shape of the end cap 6 is primarily determined by the continuous extension of the pole geometry (see FIG. 4). The topic of notch stresses is also geometry-determining since, as already mentioned, the winding is exposed to high centrifugal forces as a result of the rotational speed range and these must be absorbed in the pole geometry. This notch effect is intensified in the end cap 6 however as a result of the mass concentration of the winding head 4 and the associated greater centrifugal force per trajectory length. This means that in the 180° deflection per millimetre trajectory length, a larger proportion of winding mass must be absorbed than is the case along the pole in the sheet stack which in turn precisely in this arc geometry leads to an increased notch effect in the end cap 6 in the transition region 18.

As illustrated schematically in FIG. 4, the end cap 6 has a horizontal U-cross-sectional profile, this being suitably rounded in transition regions 18 and 19 between the upper shank 15 or lower shank 16 and the vertical side 17 of the U-profile.

For production reasons (as illustrated in FIG. 1), an interrupted geometry of the end cap 6 is expedient in order that free access for manual or machine winding is ensured (see also FIG. 4). With this open geometry of the end cap 6, however, the centrifugal forces cannot be absorbed without deformations. For this reason an additional component having a geometry as closed as possible is advantageous to relieve the end caps 6 during operation according to the invention. This is accomplished according to the invention by the support ring 7 which is therefore in force-receiving communication with the relevant end caps 6 according to the invention. These two components, i.e. the support ring 7 and the end cap 6, are geometrically and mechanically closely matched to one another in the sense of the invention with the result that they strongly influence each other in many respects. Due to the combination of these two components the stress loading in the material can fundamentally be controlled for the first time in the sense of the invention.

The choice of material for the end cap 6 has a great influence on the stresses since the stresses are directly coupled to the deformations. Our inventive considerations here were as follows:

Stiff materials such as, for example, steel (having an elastic modulus of E 207,000 MPa) impede necessary deformation and result in uncontrollable local stress peaks;

Soft materials such as, for example, polyether ether ketone (PEEK) (having an elastic module of E≈3,700 MPa) allow very large deformations with the result that an overdimensioning of the sheet stack 3 would possibly be necessary since the accumulation of mass in the winding head, as described above, must be completely absorbed in the sheet stack.

Accordingly, a solution was sought which forms a middle path from the two listed extremes. According to our experiments, aluminium alloy (having an elastic modulus of E≈70,000 MPa) offer high strength values and also the necessary deformability to compensate for unnecessarily high stresses due to elastic deformations inside the end cap and at the same time relieve the sheet stack since the centrifugal forces are not passed directly to the sheet stack.

In particular, high-strength aluminium alloys acquire significantly higher strengths compared with pure aluminium due to elements such as magnesium, silicon and copper. These mechanical properties of the preferred material AIMg1 SiCu can also be positively influenced by known treatment methods (such as, for example “T651” according to DIN EN 515 by quenching, stretching and artificial ageing). Aluminium is characterised by good thermal conductivity so that the end caps also have a cooling function when they are made of aluminium.

Since a high temperature resistance is required, this must be taken into account in the strength analysis and the design limits selected accordingly. The temperature loading of the end cap 6 during operation comprises a thermal alternating stress. For the mechanical design of the end cap 6 the material properties or the limiting values for AlMg1SiCu under elevated temperature loading were thus obtained as follows:

Elastic modulus E≈69,000 MPa;

Yield strength 190 MPa

Tensile strength Rm=210 MPa

As a result of the pre-tensioning force used, e.g. of 4700 N, of the clamping screws 10 (FIGS. 1 and 2), a pre-tensioning distance of about 0.54 mm was measured in the prototype. The axial, thermal expansion of the components is taken into account by means of the screw pre-tensioning force. A value of about 0.45 mm was taken into account for the radial thermal expansion between the end cap 6 and the support ring 7.

As a further element of the restraining system 2 according to the invention, a pole separating layer 9 is provided in the cavities between the rotor pole windings which is potted together with the winding after assembly preferably with epoxy resin or is achieved by insertion of a suitably configured plastic body. This potting of the windings is used both for the mechanical strength of the rotor stack 1 and as electrical insulation of two adjacent pole windings.

As already mentioned, very large centrifugal forces are produced in the winding heads 4 during operation of the electric motor. These forces could possibly not be completely absorbed by the end caps 6 alone which is why according to the invention the two support rings 7 of the restraining system 2 mounted on the front side are also used (FIG. 1). It should be stressed however that the individual end caps 6 can be placed on the winding heads 4, independently of the support ring 7 (and possibly an additional or integrated balancing ring, not shown).

The outer support rings 7 are optionally mounted with a small radial oversize, for the coaxial alignment, on the end caps 6 thus ensuring a loading fit for purpose since stress peaks are reduced in the end caps 6 and the loads are absorbed by the support ring 7.

After mounting the outer support rings 7, the clamping screws 10 are screwed into the right support ring 7 (FIG. 1) and tightened on the opposite side with screw-nuts 11 to a predetermined pretension. As a result of this clamping of all the components, i.e. the rotor sheet stack 1, the end caps 6 placed on both sides on the winding heads 4 and the two support rings 7, a compact and inherently stiff rotor stack 1 is obtained. This pretension of the rotor stack 1 has a value of around 4,500-4,900 N, preferably 4,700 N. Only the cavity remaining between the rotor poles can be used for screwing (FIG. 2) since through holes for the clamping screws 10 can hardly be provided in the area of the rotor windings without making compromises with regard to performance and torque.

The strength and stiffness of the rotor stack 1 attainable by the arrangement according to the invention are a requirement to achieve higher balancing quality of the rotor stack 1 in all operating states. In addition, this higher balancing quality is a basis for a further increase in the rotational speeds in a synchronous motor. Consequently, for example, rotational speeds at least a factor of 1.5 higher than are known from the previous prior art are possible. This means a significant advantage in the construction and mass production of synchronous motors for electric vehicle drives.

As is deduced from the above, due to the present invention the entire motor structure is changed with regard to its inner workings in that a freely available installation space between the sheet stack 3 and the bearing plates is now filled with the winding heads 4, end caps 6 and support rings 7. In our experience, this change brings about an increase in weight of only about 2.39 kg compared with a conventional hybrid synchronous motor operating with permanent magnet excitation but for which the disadvantages of the same must be accepted.

The screwing of the sheet stack is a central point of the mechanical rotor concept of the invention. Although the elements, i.e. the sheet stack 3 and the support rings 7 are pre-tensioned with respect to one another with this screwing, according to the invention a functional decoupling of the end caps 6 and the support rings 7 is achieved in the axial direction, which is an effect of major importance for the entire system. Consequently, the decoupling of thermal expansion of the end caps 6 made, for example, of aluminium, and the balancing quality is an important advantage of the invention. Consequently, thermal deformations and radial movements as a result of the action of centrifugal force on the end caps 6 are tolerated although without disadvantageously adversely affecting the balancing quality of the rotor stack 1 under the thermal alternating loading.

The requirements on the sheet stack screwing are therefore the rotational speed of about 12,000 rpm and also the thermal alternating loading to which the rotor stack is exposed as a result of the power loss of the pole winding (FIG. 2).

In the embodiment shown (FIGS. 1 and 2) the screw force is transferred from the support ring 7 via six supporting feet 12 distributed over the circumference to the end caps 6, or directly to the sheet stack. Normally the two support rings 7 are made of a sufficiently solid material, in particular of steel.

The supporting feet 12 of the support rings 7 can optionally be configured as fan blades to cool the arrangement. The clamping screws 10 are preferably configured as hollow screws having vanes for cooling and passage of air through the gap between the rotor poles. As a result the cooling of the electric motor can be further improved.

The clamping bolt screws 10 could be guided in an additional plastic body (not shown) which is inserted in the gap between the windings and separates respectively adjacent windings. The plastic body for holding the clamping screw 10 should conduct thermally as well as possible but not electrically. The plastic body is preferably designed so that this is anchored, for example, by form fit or similar manner permanently in the rotor stack. This results in even lower weight and a better cooling of the rotor.

Such a simplified design is also feasible in which each support ring 7 is integrated with the relevant end caps 6, preferably configured as a single piece (not shown). As a result, the manufacture of the rotor stack 1 could be further simplified although in this design the possibility of the positioning the winding by the end cap during winding of the rotor poles should be dispensed with.

The predetermined balancing weights can also be mounted (not shown) on the supporting feet 12 and/or on at least one of the support rings 7 and/or on one additional balancing ring/sheet ring fastened to the support ring 7, by which means the required balancing quality of the rotor stack 1 can be achieved. Optionally the required balancing quality of the complete rotor stack 1 can also be simply adjusted according to the invention by removal of material at predefined places on the support ring 7.

A possible further development is that the support ring 7 is not made from one piece but only from individual annular sections corresponding to the supporting feet 12 which are merely placed or glued in the region of the respective axial web of the pole shoe 5. This design has the advantages that on the one hand many more components of the same type can be manufactured and on the other hand, the costs of the injection mould and also the manufacture of the rotor stack 1 are substantially lower than in the case of the complete support ring 7.

The support construction according to the invention brings with it a particular advantage if slip rings to be acted upon axially are provided axially adjoining one of the support rings and supported on this. In this case, the overall concept of the rotor again provides the basis, functionally decoupled from the thermal expansion, for example, for an ideal contact surface for such attachment parts. In this respect this patent application can be combined with another commonly owned patent application, having the file reference EP10174941.4 and US 61/378,985 both now published via WO2012/028992A1 on Mar. 8, 2012, for the purpose of combining their teachings, and reference is expressly made to this combination (also applies for the combination of teachings from the priority applications of this application).

The invention is not restricted to the exemplary embodiments described. Further embodiments and combinations are also feasible within the claimed scope of protection on the basis of the above disclosure.

### LIST OF REFERENCE LABELS

R—Rotor
1—Rotor stack
2—Restraining system
3—Sheet stack (of the rotor)
4—Winding head
5—Pole shoe
6—End cap
7—Support ring/centrifugal force ring
8—Rotor shaft
9—Pole separating layer/pole separation
10—Clamping screw
11—Screw-nut
12—Supporting foot
13—Step
13A—Ring
14—Axial play
15—Upper shank
16—Lower shank
17—Vertical side
18—Transition region
19—Transition region

What is claimed is:

1-33. (canceled)

34. An electrical machine rotor comprising:
a rotor shaft, said shaft having an axis;
a sheet stack disposed on said rotor shaft, said sheet stack having an axial end;
a plurality of windings in said sheet stack, said windings having respective end portions projecting from said sheet stack in the axial direction;
a restraining assembly configured to protect said winding respective end portions from stresses;
said restraining assembly including axially-inner end caps on said end of said sheet stack, said end caps serving as respective geometric guides around axial edges of said sheet stack for respective ones of said windings;
and,
said restraining assembly including an axially-outer support ring operatively connected with said axially-inner end caps to absorb the centrifugal forces exerted in said end caps by said windings end portions.

35. An electrical machine rotor as claimed in claim 34, further comprising:
clamping screws connecting said end caps and said support ring to said sheet stack with a predetermined pretension to form an assembled compact rotor stack; and,
said compact rotor stack including a predetermined axial gap between said support ring and said end caps.

36. An electrical machine rotor as claimed in claim 35, further comprising:
a plurality of axial supports provided on said support ring, said axial supports contacting said sheet stack within said assembled compact rotor stack.

37. An electrical machine rotor as claimed in claim 36, further comprising:
said supports have air-guiding vanes.

38. The electrical machine rotor as claimed in claim 35, wherein:
said pretension has a value in the range of 4500-4900 N.

39. An electrical machine rotor as claimed in claim 35, further comprising:
said clamping screws are hollow for air conduction.

40. An electrical machine rotor as claimed in claim 39, further comprising:
said clamping screws have air vanes, said air vanes located at ends of said clamping screws.

41. An electrical machine rotor as claimed in claim 35, further comprising:
said clamping screws are arranged in respective pole-intermediate spaces.

42. An electrical machine rotor as claimed in claim 35, further comprising:
said clamping screws pass through plastic wedges.

43. The electrical machine rotor as claimed in claim 42, wherein:
said plastic wedges are made of a thermally conductive but electrically insulating material.

44. The electrical machine rotor as claimed in claim 34, wherein:
each of said end caps is in single-piece form and aligned on said sheet stack.

45. The electrical machine rotor as claimed in claim 34, wherein:
said end caps are made from a light metal selected from the group of light metals consisting of aluminum and Al—Mg alloy.

46. An electrical machine rotor comprising:
a rotor shaft, said shaft having an axis;
a sheet stack disposed on said rotor shaft, said sheet stack having an axial end;
a plurality of windings in said sheet stack, said windings having respective end portions projecting from said sheet stack in the axial direction;
a restraining assembly configured to protect said winding respective end portions from stresses;
said restraining assembly including axially-inner end caps on said end of said sheet stack, said end caps serving as respective geometric guides around axial edges of said sheet stack for respective ones of said windings, each of said end caps being in single-piece form and aligned on said sheet stack;
said restraining assembly including an axially-outer support ring operatively connected with said axially-inner end caps to absorb the centrifugal forces exerted in said end caps by said windings end portions;
clamping screws connecting said end caps and said support ring to said sheet stack with a predetermined pretension to form an assembled compact rotor stack, said clamping screws being arranged in respective pole-intermediate spaces;
said compact rotor stack including a predetermined axial gap between said support ring and said end caps; and,
a plurality of axial supports provided on said support ring, said axial supports contacting said sheet stack within said assembled compact rotor stack.

47. The electrical machine rotor as claimed in claim 46, wherein:
said end caps are made from a light metal selected from the group of light metals consisting of aluminum and Al—Mg alloy.

48. An electrical machine rotor as claimed in claim 46, further comprising:
said supports have air-guiding vanes.

49. The electrical machine rotor as claimed in claim 46, wherein:
said pretension has a value in the range of 4500-4900 N.

50. An electrical machine rotor as claimed in claim 46, further comprising:
said clamping screws are hollow for air conduction.

51. An electrical machine rotor as claimed in claim 50, further comprising:
said clamping screws have air vanes, said air vanes located at ends of said clamping screws.

52. An electrical machine rotor as claimed in claim 46, further comprising:
said clamping screws pass through plastic wedges.

53. The electrical machine rotor as claimed in claim 52, wherein:
said plastic wedges are made of a thermally conductive but electrically insulating material.
